(19) United States
(12) Patent Application Publication
(10) Pub. No.: US 2022/0254213 A1
(43) Pub. Date: Aug. 11, 2022

(54) Control Device of Electronic Lock

(71) Applicant: Jeff Chen, Chiayi County (TW)

(72) Inventor: Jeff Chen, Chiayi County (TW)

(21) Appl. No.: 17/465,868

(22) Filed: Sep. 3, 2021

(30) Foreign Application Priority Data
Feb. 9, 2021 (TW) 110201656

(51) Int. Cl. G07C 9/30; G07C 9/00; F21V 8/00

(52) U.S. Cl. CPC G07C 9/30; G02B 6/0008; G07C 9/00944

(57) ABSTRACT

A control device of electronic lock is provided for electrically connecting with a lock device of the electronic lock, so as to be adapted for controlling the operation of the lock device. The control device comprises a base plate, a circuit board, a plurality of illuminants, a plurality of communication resilience members, a lid locked on the base plate, an alignment plate, and a touch panel. The illuminants are arranged corresponding to the communication resilience members respectively. The touch panel is electrically connected with the communication resilience members. When the touch panel is touched, the communication resilience member corresponding to the touched position is electrically communicated with the circuit board, that consequently triggers the corresponding illuminant to emit light. The communication resilience members are guided and aligned through the alignment plate so as to avoid signal interference thereamong. Hence, the use of the control device not only illuminates to illustrate the touch positions, but also certainly prevents signal interference, so as to enable a more convenient operation.

### BACKGROUND OF THE PRESENT INVENTION

### Field of Invention

The present invention relates to a control device of electronic lock, and more particularly, to a control device of electronic lock which is capable of emitting light while being touched to control.

### Description of Related Arts

In recent years, various technologies develop quickly, electronic devices have commonly utilized and mechanical parts have become more and more compact in size that allows electronic locks to be invented and developed. In addition to the economic boost, high-end buildings, such as office buildings or elite residential buildings, have wildly established. People pursue a more secure residence. Therefore, electronic locks are gradually accepted and utilized to replace the traditional locks. In particular, electronic touch controlling system has been boosted with the applications of smartphones that such technologies are mature with lower costs and thus further accelerate the applications of electronic locks. The present invention provides a novelelectronic lock configuration that integrates touch controlling technologies with electronic device. Some prior technologies relevant to electronic locks and touch controlling technology include the following Taiwan patents, application numbers 104216291, 108100756, 104122677, 105131441, and 104123165.

### SUMMARY OF THE PRESENT INVENTION

Hence, an object of the present invention is to provide a control device of an easy-to-control electronic lock.

Accordingly, the present invention provides a control device of electronic lock which is electrically connected with a lock device of the electronic lock, so as to be adapted for controlling the operation of the lock device. The control device comprises a base plate, a circuit board insulatedly arranged on the base plate, a plurality of illuminants arranged on the circuit board, a plurality of communication resilience members separately affixed on the circuit board, a lid locked on the base plate, an alignment plate affixed on the inner side of the lid for guiding and aligning the communication resilience members, and a touch panel arranged on the lid and adjacent to the alignment plate. The illuminants are arranged corresponding to the communication resilience members respectively. The touch panel is electrically connected with the communication resilience members. When the touch panel is touched, the communication resilience member corresponding to the touched position is electrically conducted with the circuit board, which also consequently triggers the corresponding illuminant to emit light. Meanwhile, the circuit board transmits the electric signal to the lock device. The communication resilience members are guided and aligned through the alignment plate, so as to avoid signal interference thereamong. Hence, the control device can not only illuminate to illustrate the touch positions, but also certainly prevent signal interference while the electronic lock is being used and operated to ensure a more convenient operation.

### BRIEF DESCRIPTION OF THE DRAWINGS

FIG. 1 is a perspective view of a control device of electronic lock according to a preferred embodiment of the present invention.

FIG. 2 is an exploded view of the control device of electronic lock according to the above preferred embodiment of the present invention.

FIG. 3 is a sectional view of the control device of electronic lock according to the above preferred embodiment of the present invention.

### DETAILED DESCRIPTION OF THE PREFERRED EMBODIMENT

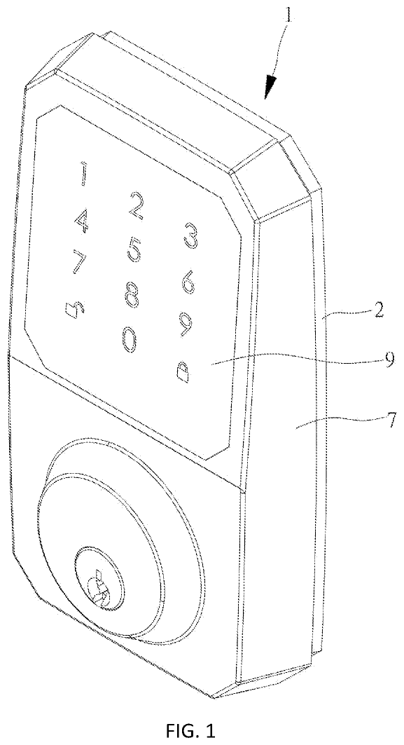

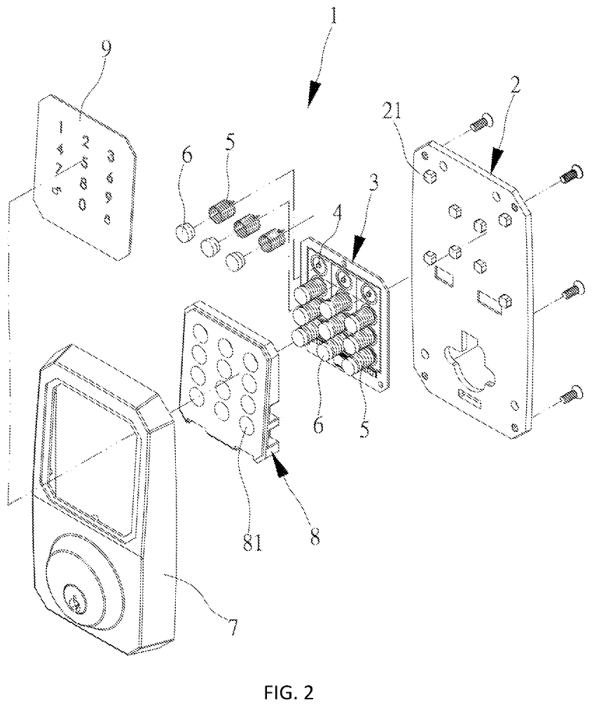

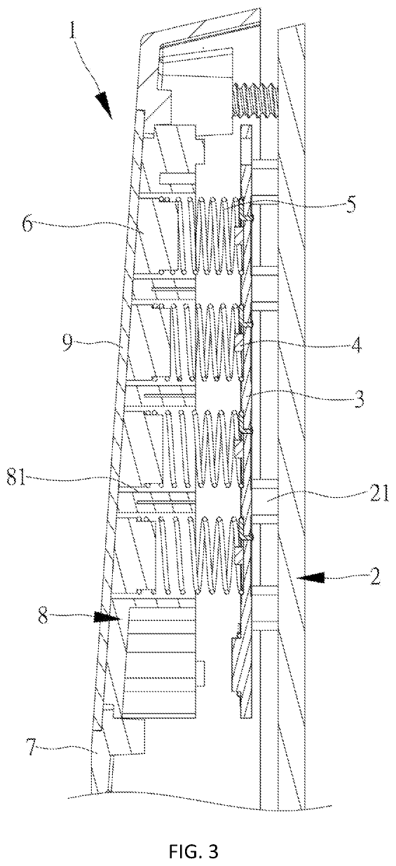

Referring to FIGS. 1-3, the control device of electronic lock 1 according to a preferred embodiment of the present invention is electrically connected with a lock device of an electronic lock (not shown in the drawings). The lock device may be assembled on a door (not shown in the drawings) according to the present embodiment, wherein the control device 1 is for controlling the operation of the lock device for unlocking or locking the door. The control device 1 has a base plate 2, a circuit board 3 insulatedly arranged on the base plate 2, a plurality of illuminants 4 arranged on the circuit board 3, a plurality of communication resilience members 5 separately affixed on the circuit board 3, a plurality of light guide members 6 correspondingly arranged on the communication resilience members 5 respectively, a lid 7 locked on the base plate 2, an alignment plate 8 affixed on the inner side of the lid 7 for guiding and aligning the communication resilience members 5, and a touch panel 9 arranged on the outer side of the lid 7. The base plate 2 comprises a plurality of insulating pieces 21 protrudingly arranged thereon, wherein the circuit board 3 is arranged on top of the insulating pieces 21 and is electrically connected with the lock device. The illuminants 4 are arranged corresponding to the communication resilience members 5 respectively. The light guide members 6 are correspondingly arranged between the touch panel 9 and the communication resilience members 5 respectively. The lid 7 is adapted to cover and wrap the circuit board 3, the illuminants 4, the communication resilience members 5, the light guide members 6, and the alignment plate 8 on top of the base plate 2. The alignment plate 8 has a plurality of alignment holes 81 provided therein. The alignment holes 81 are adapted for accommodating the communication resilience members 5 and the light guide members 6 correspondingly and respectively. The light guide members 6 is adapted for the light of the illuminants 4 to evenly and uniformly pass through respectively while the material thereof is electrically conductible. Also, the touch panel 9 is adjacent to the alignment plate 8 and contacted with the light guide members 6, while being electrically connected with the communication resilience members 5 through the light guide members 6, so as for transmitting electric signals to the circuit board 3. Besides, the touch panel 9 may, based on the needs, comprise various touch positions and areas, such as the touch position with a plurality of numbers, as illustrated in the drawings of the present embodiment, so as for inputting the unlock code.

To utilize the device, when the user touches any position of the touch panel 9, such as the position of the number 5 provided on the touch panel 9, the electric signal sent by the touch panel 9 is immediately transmitted to the circuit board 3 through the corresponding light guide member 6 and communication resilience member 5 that triggers the corresponding illuminant 4 to emit light. The light is guided through the light guide member 6 to be evenly and uniformly displayed on the position of the numbers 5 on the touch panel 9. When the user completely inputs the designated number through the touch panel 9, the circuit board 3 electrically controls the lock device to lock or unlock. The communication resilience members 5 and the light guide members 6 are respectively limited in the corresponding alignment holes 81 to ensure being separated from adjacent communication resilience members 5, that prevents signal interference thereamong. Furthermore, the circuit board 3 is arranged on the insulating pieces 21 on the base plate 2 for surely blocking external noise. Hence, the use of the control device 1 not only illuminates and displays the touch positions, but also certainly prevents signal interference, so as to enable a more convenient operation.

What is claimed is:

1. A control device of electronic lock adapted for electrically connected with a lock device of an electronic lock for controlling an operation of the lock device, comprising:
a base plate;
a circuit board insulatedly arranged on said base plate for transmitting electrical signal to the lock device;
a plurality of communication resilience members separately affixed on said circuit board;
a plurality of illuminants arranged on said circuit board corresponding to said plurality of communication resilience members respectively;
a lid locked on said base plate;
an alignment plate affixed on an inner side of said lid for guiding and aligning said communication resilience members; and
a touch panel arranged on said lid and adjacent to said alignment plate, wherein said touch panel is electrically connected with said plurality of communication resilience members, such that when said touch panel is touched at a touch position thereof, said plurality of communication resilience members corresponding to said touched position is electrically communicated with said circuit board, that triggers at least one corresponding illuminant of said plurality of illuminants to emit light.

2. The control device of electronic lock, as recited in claim 1, wherein said control device further comprises a plurality of light guide members correspondingly arranged between said touch panel and said communication resilience members respectively.

3. The control device of electronic lock, as recited in claim 1, wherein said base plate comprises a plurality of insulating pieces protrudingly arranged thereon, wherein said circuit board is arranged on top of said insulating pieces.

4. The control device of electronic lock, as recited in claim 2, wherein said alignment plate has a plurality of alignment holes adapted for respectively accommodating said communication resilience members and said light guide members correspondingly.
